(19) United States
(12) Patent Application Publication
(10) Pub. No.: US 2003/0140506 A1
(43) Pub. Date: Jul. 31, 2003

(54) Power saw for reducing the width of window casings without removal of casing boards-sill saw

(76) Inventor: John Charles Cavin, Cove, OR (US)

Correspondence Address: Mr. John Cavin, 1004 Haefer Lane, Cove, OR, 97824, US

(21) Appl. No.: 10/059,891

(22) Filed: Jan. 31, 2002

(51) Int. Cl. B27B 9/04

(52) U.S. Cl. 30/371; 30/388

(57) ABSTRACT

The subject of this patent application, the Sill Saw, is an application-specific handheld circular power saw that affords the replacement of narrow frame windows, usually aluminum frame windows, with windows having thicker (deeper) frames, without the removal of the window casing materials or associated inside window moldings. This handheld power tool is specifically designed for the purpose of sawing window casing boards to a narrower width without removing them from the structure. There is no other method of accomplishing this, short of disassembling the window components, installing the new window, modifying the removed components and reinstalling them. Current, general purpose, handheld power saws cannot cut the window casing boards completely to the corners; that is, to their intersections with one another. This can be accomplished using the subject of this patent application, the Sill Saw.

### CROSS-REFERENCE TO RELATED APPLICATIONS

Not applicable

### STATEMENT REGARDING FEDERALLY SPONSORED RESEARCH OR DEVELOPMENT.

Not applicable

### REFERENCE TO A MICROFICHE APPENDIX

Not applicable

### BACKGROUND OF INVENTION

Recent increases in the cost of heating and cooling commercial and residential buildings, have led to the widespread desire to replace heat-conducting aluminum-framed windows with windows that have better thermal insulating properties, typically utilizing multiple panes of glass, and either wood or vinyl for the frame material. These materials and features cause the frames of the vinyl- and wood-framed windows to be thicker than the frames of the aluminum-framed windows which they replace. That is, the dimension from the outermost surface of the window frame to the innermost surface, relative to the wall into which it is installed, is greater for vinyl and wood frames than it is for aluminum frames.

Replacement windows are designed and sized to fit into the exact space created by the removal of the aluminum window frame. If the wider-framed window is simply installed into the existing opening, the new window frame protrudes from the building in an unaesthetic manner. There are currently two approaches in dealing with the problem of the replacement windows' thicker frames.

One involves the removal and modification of the casing. The casing pieces can be described as the exposed molding or framing around a window, which covers the space between the window frame or jamb and the wall. They consist most commonly of four pieces of wood; two horizontal, one each at the top and bottom of the window opening and two vertical, one on each side of the window opening. The bottom horizontal casing board is usually called the sill. If the casing pieces are to be reused, which is the usual case, removing the casing involves the meticulous disassembly of the various parts of the window system. The nails securing the individual casing boards to the rough window frame must be either 1.) pulled or 2.) sawed off with a metal cutting blade by accessing the nails in the interstitial space between the rough window frame and the casing board. This must be accomplished with minimal damage to the casing materials. The four casing pieces are then reduced in width, usually by putting the individual pieces through a table saw. After the new windows are installed, the pieces must then be reinstalled in the window opening, have the nail holes puttied, and then be sanded and painted. Other, inside window molding pieces will usually have to be removed, refurbished and reinstalled or replaced as well. This is a material, labor and time consuming process.

Utilizing the second method, the wider-framed window is simply installed into the existing opening, allowing the new window frame to protrude from the building in an unaesthetic manner.

There is another heretofore unavailable solution. That would be to have a handheld power tool specifically designed for the purpose of sawing the casing boards to a narrower width without removing them from the structure. Current, general purpose handheld power saws cannot cut the casing boards completely to the corners; that is, to their intersections with one another. This can be accomplished using the subject of this patent application—the Sill Saw; an application-specific handheld circular power saw that affords the replacement of aluminum windows with windows having thicker (deeper) frames, without the removal of the window casing.

### BRIEF DESCRIPTION OF THE SEVERAL VIEWS OF THE DRAWING

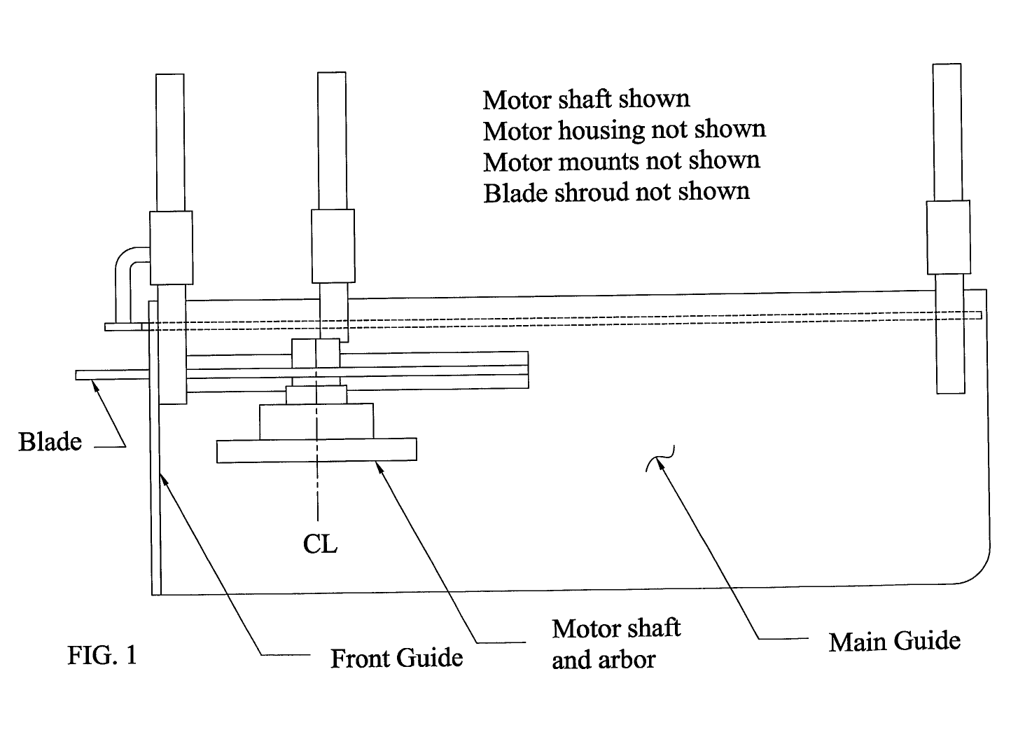

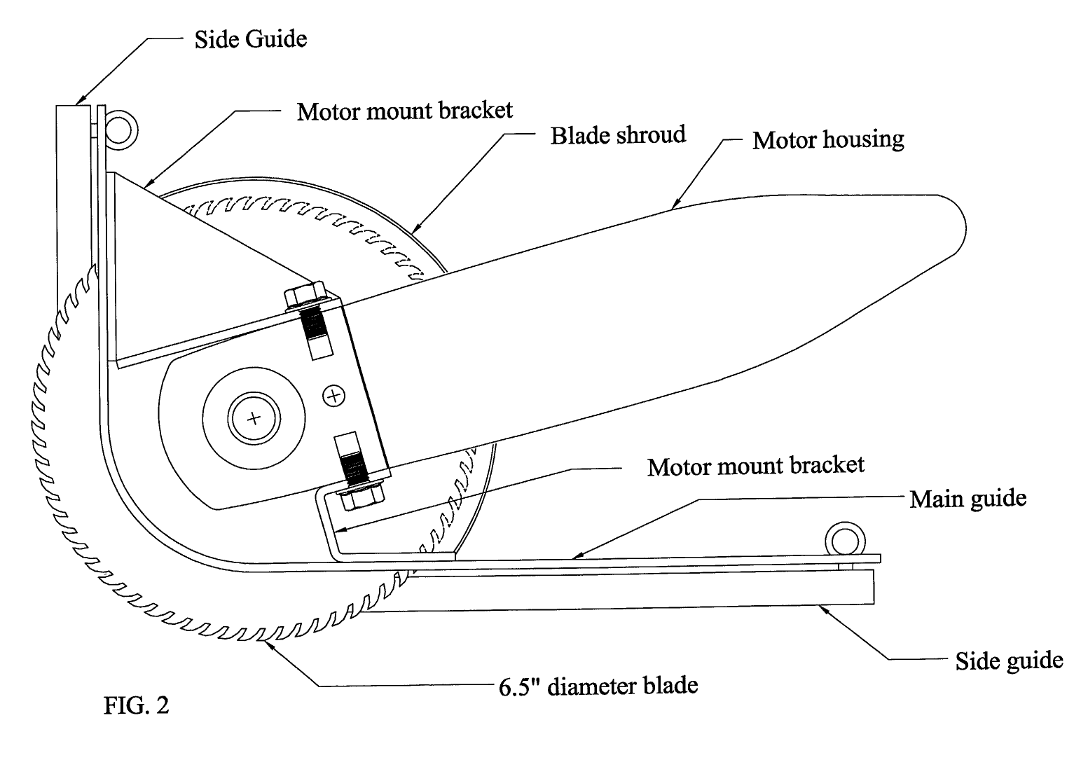

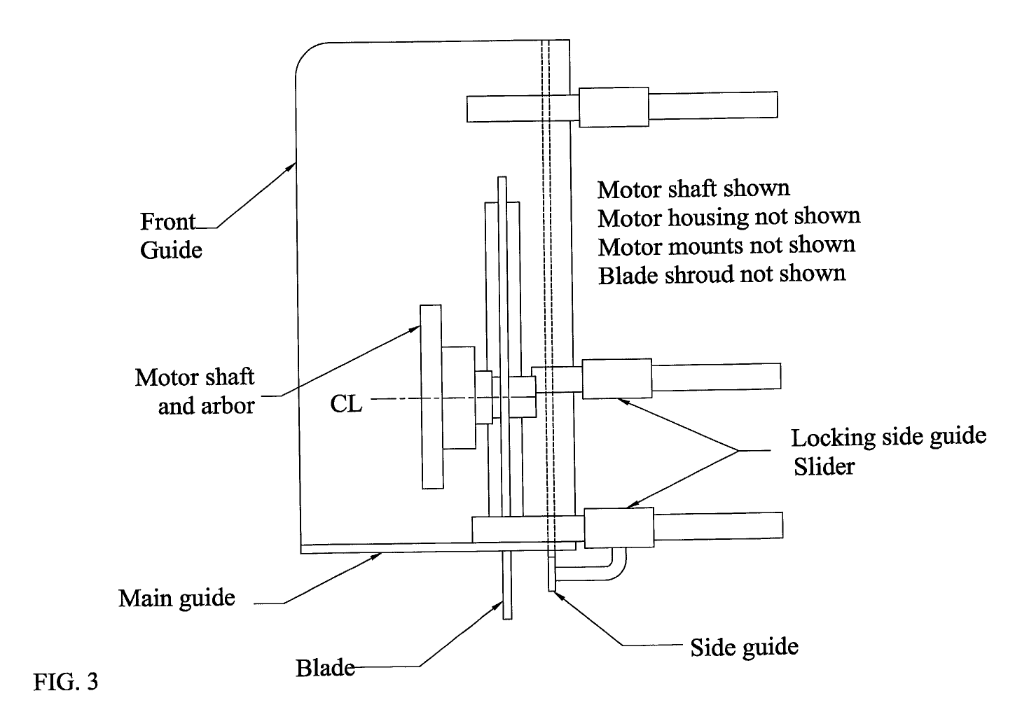

This patent application has, included with it, four drawing sheets. The drawing marked “1/1” is the top sheet, showing the Sill Saw in three views. Sheet 2/2 (FIG. 2) depicts the Sill Saw as seen from the side, showing how the blade protrudes through the blade slot in the guide. Sheet 3/4 (FIG. 3) depicts the Sill Saw from the aft position, showing the orientation of the side guide and the protrusion of the blade through the blade slot in the guide. Sheet 4/4 (FIG. 1) is the view from above the saw, showing the blade protruding through the blade slot in the front of the guide.

### BRIEF DESCRIPTION OF THE INVENTION

The circular blade of the Sill Saw protrudes through not only the bottom of the main guide but also protrudes from the front of the main guide. The Sill Saw is able to saw each board completely to the corner and into the intersection of the adjacent perpendicular board. Removal of the casing boards and other molding pieces is not required.

Once the aluminum-framed window is removed, the design of the Sill Saw allows the window casing boards to be reduced in width without removing them or other molding pieces from the window opening. The bottom of the main guide rides along the sill or casing board and the side guide rides along the inside or outside edge of the casing board, providing lateral guidance for the longitudinal cutting path.

### DETAILED DESCRIPTION OF THE INVENTION

The prototype Sill Saw accomplishes the sawing of casing boards, in place, utilizing a singular, one-piece, fixed main guide with the blade protruding beyond the front of the main guide as well as below the main guide. The same result could be accomplished using several other methods of allowing the blade to extend beyond and through both the bottom and front of the main guide. If instead of having the blade protrude from the front of the main guide in a fixed configuration, the blade and guide were constructed in a manner that allowed the blade to plunge through the blade slot in the front main guide, the same result would be accomplished. Using the aforementioned configuration, the main guide would, of course, stop when it came in contact with the next adjacent perpendicular casing board but the blade and or the motor of the Sill Saw would continue to move forward as the blade plunged through the blade slot and front guide and into the casing material, sawing it completely to the corner. The design would allow for the blade and front guide to latch in this configuration, if preferred, so the spring loaded guide would not be forced back into the extended position (thereby retracting the blade) before this action was desired.

Another method involves a compound or multi-part main guide. The bottom section of the multi-part main guide could remain fixed. The front section on the multi-part guide would retract as the front guide contacts the adjacent casing board, allowing the blade to extend though the blade slot, beyond the guide and into the adjacent perpendicular casing board.

1. I claim the capability of a handheld power saw with a rotating, reciprocating, or polar reciprocating blade to saw into the intersection of adjacent window casing boards, by having the blade fixed (relative to the blade guide(s)) in a configuration that allows the blade to protrude through the blade slot in both the bottom and front of the main guide(s), including the configuration where there is no front portion of the main guide, per se, as in FIG. 2.

2. I claim the capability of a handheld power saw with a rotating, reciprocating, or polar reciprocating blade to saw into the intersection of adjacent window casing boards, by having the saw blade plunge through the blade slot in the front and or bottom of the main guide, including the configuration where there is no front portion of the main guide, per se, but the blade does have the capability to plunge forward, through the blade slot, cutting the adjacent board.

3. I claim the capability of a handheld power saw with a rotating, reciprocating, or polar reciprocating blade to saw into the intersection of adjacent window casing boards by having any portion of the main guide retract (thereby causing the blade to protrude through the blade slot of the guide) either manually or when any portion of the saw comes into contact with the casing boards or any other part of the window or temporary parts of the window.

4. I claim the blade/blade guide configuration of a handheld power saw, whereby the rotating, reciprocating, or polar reciprocating blade of the saw is able and capable of protruding through and sawing materials beyond any and all blade guides for the purpose of sawing, in place, (i.e. without removing from the existing system) window casing boards, completely into the intersection of (usually) intersecting, (usually) perpendicular adjacent window casing boards, in such a manner that the saw blade penetrates the intersection of the adjacent perpendicular board as well as the adjacent perpendicular board itself and I claim this capability and configuration irrespective of the mechanism allowing the blade to protrude past the guides and into the intersecting casing materials.
